(19) United States
(12) Patent Application Publication
(10) Pub. No.: US 2026/0019099 A1
(43) Pub. Date: Jan. 15, 2026

(54) PASSIVE INTERMODULATION REMOVAL USING A MACHINE LEARNING MODEL

(71) Applicant: Telefonaktiebolaget LM Ericsson (publ), Stockholm (SE)

(72) Inventors: Fredrik Diffner, Stockholm (SE); Jared Keown, Sundbyberg (SE); Gagan Gupta, Sollentuna (SE); Sumedh Dhabu, Toronto (CA); Serveh Shalmashi, Enebyberg (SE); Jin Ellgardt, Sundbyberg (SE); Vidit Saxena, Järfälla (SE)

(21) Appl. No.: 18/994,387

(22) PCT Filed: Jul. 15, 2022
(86) PCT No.: PCT/EP2022/069855

§ 371 Date: Jan. 14, 2025

(51) Int. Cl. H04B 1/10; G06N 3/048; H04B 1/52

(52) U.S. Cl. CPC H04B 1/109; G06N 3/048; H04B 1/52

(57) ABSTRACT

A method comprises transmitting a transmit signal via a transmit radio chain and over-the-air from an antenna system and generating a predicted PIM signal for the transmit signal using a non-linear machine learning model by transforming the transmit signal to a signal feature representation composed of delay-aligned discrete-time samples and at least one discrete-time phase offset. The non-linear machine learning model uses a first neural network column for the delay-aligned discrete-time samples and a second neural network column for the at least one discrete-time phase offset. The predicted PIM signal is obtained as output from the non-linear machine learning model when the signal feature representation is fed as input to the non-linear machine learning model. The method comprises receiving a receive signal over-the-air at the antenna system and via a receive radio chain and removing PIM from the receive signal by subtracting the predicted PIM signal from the receive signal.

### TECHNICAL FIELD

Embodiments presented herein relate to a method, a controller, a computer program, and a computer program product for passive intermodulation removal in a network node.

### BACKGROUND

In general terms, passive intermodulation (PIM) is a type of distortion generated by nonlinearity of passive components, such as filters, duplexers, connectors, antennas and so forth at a cell site. PIM is thus an intermodulation product that can occur when two or more signals pass through passive components, introducing non-linear distortion to the signals. Depending on the location of the component that generates the PIM, the PIM is categorized as either internal or external. For example, PIM generated by the filters of the transmission (TX) radio chains in the antenna system at the cell site is called internal PIM whereas PIM generated by a metal fence on the roof top of a building, or even rusty bolts, in vicinity of the cell site is called external PIM. Typically, the power level of the PIM component is much lower in magnitude than the signal it originates from. Nevertheless, PIM becomes problematic in a cellular network when strong transmitted signals used for sending information to user equipment interact with the source of the PIM, hereinafter referred to as a PIM source. Interaction with one or more PIM source might cause noise to be introduced in the frequency band used to detect weaker received signals from served user equipment. This distortion of the received signals decreases the reliability, capacity, and data rate of wireless systems.

Different approaches have been proposed for PIM mitigation. In one example, the transmitter power is reduced to effectively lower the PIM level. One drawback is reduced coverage and/or downlink throughput. In another example, expensive high-quality components are used at the TX radio chains. This might reduce internal PIM but will not affect the external PIM. In another example the frequency bands for transmission and/or reception is/are selected from a part of the frequency spectrum with less PIM distortions. This is not always possible as the frequency bands might be licensed and the available frequency spectrum is limited.

Another approach for PIM mitigation is PIM cancellation. PIM cancellation aims to use the transmit signals and receive signals to create a model for the PIM source(s) that are affecting the receive signal. This model is then used to create a replica signal of the PIM signal that impacts the receive signal. The replica signal is then subtracted from the receive signal to obtain a cleaner version of the receive signal. One way to create such a model is by using time domain transmitted signals (e.g., user plane data). In this case, the design problem (i.e., how to create an accurate replica signal) can then be regarded as a time series regression problem. Predicting the PIM in the frequency band for the receive signal is traditionally done with memoryless polynomials. In brief, a set of basis vectors are fit with weights through a least mean square (LMS) criterion, or similar.

Some issues with traditional approaches for PIM cancellation will be disclosed next.

Appropriate frequency shift(s) is required to place the generated non-linear model(s) at the correct location with respect to the receive signal. Since each PIM source will cause different intermodulation components, each model needs to be fit to each separate environment with PIM sources.

Traditional approaches for PIM cancellation have limitations regarding how complex the model can be. In general, the highest order of the PIM that is to be considered for cancellation needs to be determined a priori to make design choices, such as the sample rate at which the processing is to be performed. This limits the PIM cancellation performance.

Further, polynomial-based models typically used for PIM cancellation might have limited PIM cancellation performance due to their limited learning capacity. This limitation is especially prevalent for strong PIM sources, which are oftentimes problematic for traditional approaches for PIM cancellation.

Hence, there is still a need for improved PIM cancellation.

### SUMMARY

An object of embodiments herein is to address the above issues with traditional approaches for PIM cancellation.

According to a first aspect there is presented a method for PIM removal in a network node. The network node comprises a transmit radio chain, a receive radio chain, and an antenna system. The method is performed by a controller. The method comprises transmitting a transmit signal via the transmit radio chain and over-the-air from the antenna system. The method comprises generating a predicted PIM signal for the transmit signal using a non-linear machine learning model by transforming the transmit signal to a signal feature representation composed of delay-aligned discrete-time samples and at least one discrete-time phase offset. The non-linear machine learning model 400 is of an architecture that uses a first neural network column for the delay-aligned discrete-time samples and a second neural network column for the at least one discrete-time phase offset. The predicted PIM signal is obtained as output from the non-linear machine learning model when the signal feature representation is fed as input to the non-linear machine learning model. The method comprises receiving a receive signal over-the-air at the antenna system and via the receive radio chain. The method comprises removing PIM from the receive signal by subtracting the predicted PIM signal from the receive signal.

According to a second aspect there is presented a controller for PIM removal in a network node. The network node comprises a transmit radio chain, a receive radio chain, and an antenna system. The controller comprises processing circuitry. The processing circuitry is configured to cause the controller to transmit a transmit signal via the transmit radio chain and over-the-air from the antenna system. The processing circuitry is configured to cause the controller to generate a predicted PIM signal for the transmit signal using a non-linear machine learning model by transforming the transmit signal to a signal feature representation composed of delay-aligned discrete-time samples and at least one discrete-time phase offset. The non-linear machine learning model 400 is of an architecture that uses a first neural network column for the delay-aligned discrete-time samples and a second neural network column for the at least one discrete-time phase offset. The predicted PIM signal is obtained as output from the non-linear machine learning model when the signal feature representation is fed as input to the non-linear machine learning model. The processing circuitry is configured to cause the controller to receive a receive signal over-the-air at the antenna system and via the receive radio chain. The processing circuitry is configured to cause the controller to remove PIM from the receive signal by subtracting the predicted PIM signal from the receive signal.

According to a third aspect there is presented a controller for PIM removal in a network node. The network node comprises a transmit radio chain, a receive radio chain, and an antenna system. The controller comprises a transmit module configured to transmit a transmit signal via the transmit radio chain and over-the-air from the antenna system. The controller comprises a generate module configured to generate a predicted PIM signal for the transmit signal using a non-linear machine learning model by transforming the transmit signal to a signal feature representation composed of delay-aligned discrete-time samples and at least one discrete-time phase offset. The non-linear machine learning model 400 is of an architecture that uses a first neural network column for the delay-aligned discrete-time samples and a second neural network column for the at least one discrete-time phase offset. The predicted PIM signal is obtained as output from the non-linear machine learning model when the signal feature representation is fed as input to the non-linear machine learning model. The controller comprises a receive module configured to receive a receive signal over-the-air at the antenna system and via the receive radio chain. The controller comprises a remove module configured to remove PIM from the receive signal by subtracting the predicted PIM signal from the receive signal.

According to a fourth aspect there is presented a computer program for PIM removal in a network node, the computer program comprising computer program code which, when run on a controller, causes the controller to perform a method according to the first aspect.

According to a fifth aspect there is presented a computer program product comprising a computer program according to the fourth aspect and a computer readable storage medium on which the computer program is stored. The computer readable storage medium could be a non-transitory computer readable storage medium.

Advantageously, these aspects provide efficient PIM cancellation without experiencing the issues disclosed above.

Advantageously, these aspects improve the PIM cancellation compared to the state-of-the-art. Compared to traditional approaches, the estimation of the PIM as disclosed herein is more accurate, and therefore performs better in terms of PIM cancellation. For a wide range of evaluated configurations, the numerical gains for PIM cancellation is found to be between 5 dB to 20 dB. This translates into significantly better receiver sensitivity and hence improved overall performance of the radio system.

Advantageously, these aspects can be combined with feature ranking to identify input features (e.g., time steps, signals, etc.) that have a relatively low contribution to the PIM prediction. The feature ranking can then be used to down select input features, which reduces the computational complexity of the non-linear machine learning model whilst preserving the predictive performance.

Advantageously, these aspects are PIM-order agnostic. Contrary to traditional PIM cancellation approaches, the highest order of the PIM to be considered for cancellation does not need to be defined to create corresponding non-linear terms. As a corollary, the herein disclosed techniques for PIM cancellation can be used at a lower sample rate than traditional PIM cancellation approaches to perform higher order PIM cancellation.

Advantageously, these aspects offer flexibility in terms of learning common neural basis functions across several PIM sources, with fine-tuning only required on a single neural network layer rather than training a full model for every PIM source. This attribute allows the herein disclosed techniques for PIM cancellation to be scalable to real-world PIM cancellation settings where the PIM cancellation must quickly adapt to new PIM sources or changes to the PIM signatures whilst maintaining a low modeling complexity.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 schematically illustrates a communication system according to embodiments;

FIG. 2 is a first block diagram of a network node according to embodiments;

FIG. 3 is a second block diagram of a network node according to embodiments;

FIG. 4 schematically illustrates a non-linear machine learning model for PIM cancellation according to embodiments;

FIG. 5 shows processed signals at different stages of the PIM cancellation according to embodiments;

FIG. 6 is a flowchart of methods according to embodiments;

FIG. 7 schematically illustrates a first architecture of a non-linear machine learning model according to embodiments;

FIG. 8 schematically illustrates a second architecture of a non-linear machine learning model according to embodiments;

FIG. 9 is a plot of accumulated score retrieved for each lag in transmit signals according to embodiments;

FIG. 10 schematically illustrates a two-column architecture of a non-linear machine learning model according to embodiments;

FIG. 11 schematically illustrates nonlinear basis function learning using training data aggregated from several testcases according to embodiments;

FIG. 12 is block diagram for training a non-linear machine learning model for PIM cancellation according to embodiments;

FIG. 13 is a block diagram for performing PIM cancellation using a non-linear machine learning model according to embodiments;

FIG. 14 show simulation results according to embodiments;

FIG. 15 is a schematic diagram showing functional units of a controller according to an embodiment;

FIG. 16 is a schematic diagram showing functional modules of a controller according to an embodiment;

FIG. 17 shows one example of a computer program product comprising computer readable storage medium according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

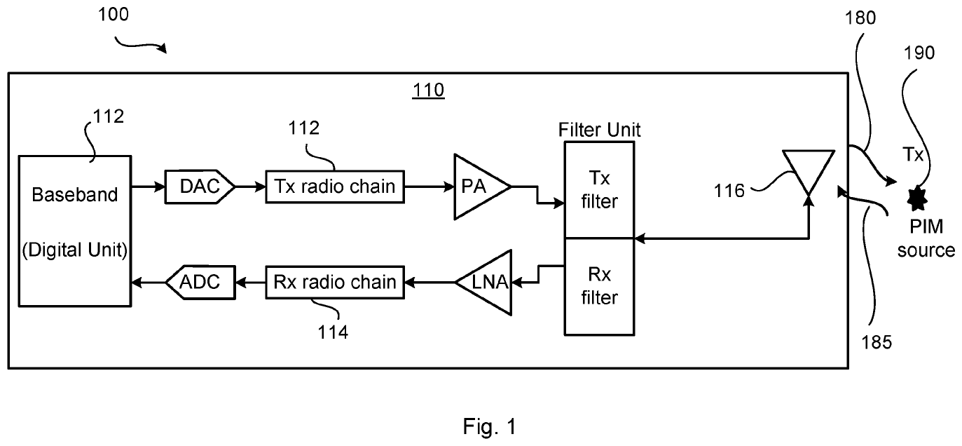

In FIG. 1 is shown a communication system 100 comprising a block diagram of a network node 110 and an external PIM source 190. The network node 110 comprises a (digital) baseband unit 111, a transmit radio chain 112 (along which is placed a digital to analogue (DAC) converter, a power amplifier (PA) and a transmit (Tx) filter), a receive radio chain 114 (along which is placed a receive (Rx) filter, a low noise amplifier (LNA), and an analogue to digital (ADC) converter), and an antenna system 116. As is understood, in this respect the network node 110 might comprise a plurality of transmit radio chains, a plurality of receive radio chains, and/or more than one antenna system. In FIG. 1 is further illustrated an external PIM source 190 that, when being impinged by a transmit signal 180 as transmitted by the transmit radio chain 112, causes PIM to a receive signal 185 to be passed on to the receive radio chain 114 from the antenna system 116.

As disclosed above, there is still a need for improved PIM cancellation.

In further detail, flexible PIM cancellation techniques that are enabled to handle all types of PIM sources are required to address the PIM problems in modern networks. In regard to decreasing the complexity of the PIM cancellation, the input feature dimensionality is often important but has been ignored in the prior art related to PIM cancellation. Techniques that can also reduce the input features required to perform PIM cancellation are valuable due to the computational limitations of the hardware typically used for PIM cancellation. PIM cancellation techniques that obtain high cancellation performance with few input features are preferred because they cut down on computational costs and energy usage. For example, traditional PIM cancellation techniques use a pre-defined time window of previous samples (e.g., the previous 16 samples) when modeling a given PIM source. Although all of these time-lagged samples are included as inputs into the model, only a subset of the time steps might be useful for actually modelling the PIM.

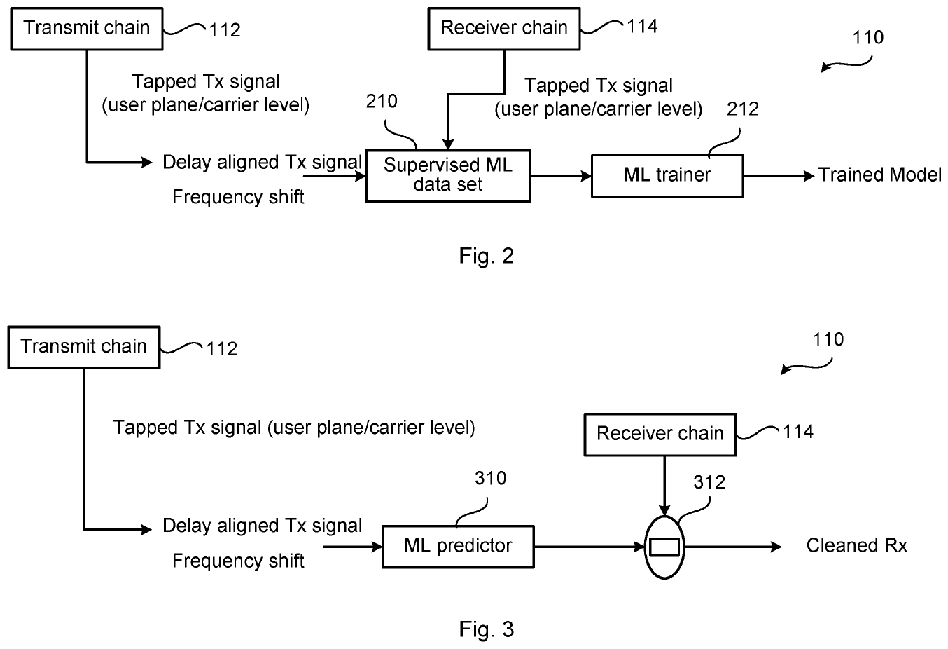

General principles of how PIM caused by the PIM source 190 can be cancelled by means of using a non-linear machine learning model will be disclosed next with reference to FIG. 2 and FIG. 3.

FIG. 2 provides a block diagram of the network node 110. In particular, in FIG. 2 is illustrated that the transmit signal and the receive signal are collected in a supervised dataset 210 that is used for trainer 212 of a non-linear machine learning model (without any actual PIM cancellation being performed). Accordingly, since a dataset with PIM for different PIM source features (as defined below) can be retrieved, training of the non-linear machine learning model can be treated as a supervised time series regression problem. The overall approach is that a set of transmit signals and receive signals is used to train, and possibly finetune, the non-linear machine learning model. Each sample of the receive signal in the training dataset is considered as the label for the supervised time series regression problem. Training, or finetuning, of the non-linear machine learning model is performed in absence of PIM cancellation. This is to ensure that the receiver sensitivity is not degraded during the training, or finetuning, process. Once the training, or finetuning is complete, the non-linear machine learning model is used to predict the PIM in the receive signal on a per sample basis. This is illustrated in the further block diagram of the network node 110 in FIG. 3. In particular, in FIG. 3 is illustrated that the transmit signal is fed into the a predictor 310 for predicting the PIM and then in a subtractor 312 subtracting the predicted PIM from the receive signal, resulting in a cleaned receive signal.

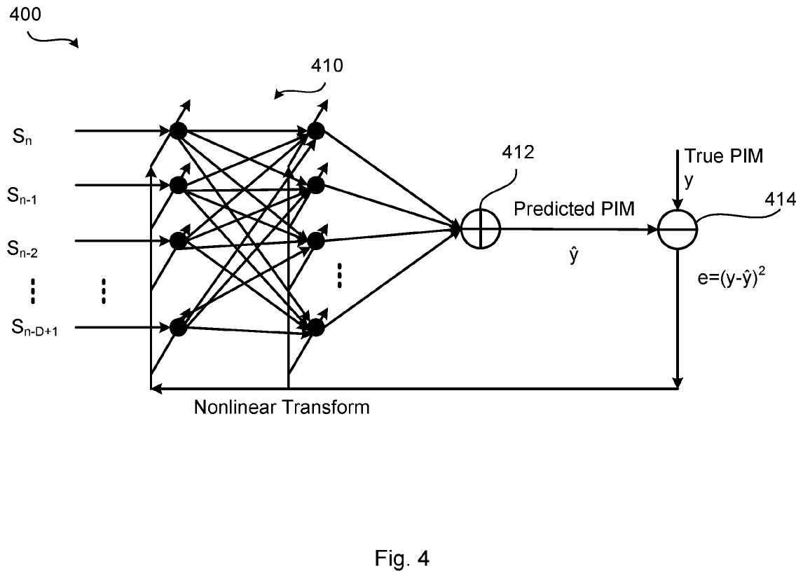

General principles of how the non-linear machine learning model can be used to predict the PIM will be disclosed next with reference to FIG. 4. In FIG. 4 is illustrated a non-linear machine learning model 400 for PIM cancellation in the form of a neural network 410. The input to the non-linear machine learning model 400 is a set of time-lagged PIM source features denoted Sₙ, Sₙ₋₁, Sₙ₋₂, . . . , S_{n-D+1}. The PIM source features at sampling instance n are denoted by sₙ. In some examples, the PIM source features are represented via tensors that contains one or more dimensions. These PIM source features correspond to the current sampling instance, n, and one or more previous sampling instances, n−1, . . . , n−D+1, where D denotes the maximum sampling lag. In some examples, the PIM source features comprise one or more transmit signals, one or more numerically controlled oscillator (NCO) features, and (optionally) additional features. Particularly, in some non-limiting examples, the signal feature representation (defined by the PIM source features) further is composed of any, or any combination, of: absolute value of the transmit signals 180, partial non-linear terms created from the transmit signal 180, statistics of N previous delay-aligned discrete-time samples, a weighted linear combination of the N previous delay-aligned discrete-time samples. The neural network model contains one or more nonlinear layers followed by one or more linear layers that together generate a predicted PIM at the current sampling instance, and a mechanism to fit the predicted PIM to the received (true) PIM. A linear combiner 412 forms the predicted PIM. An error between the predicted PIM and the true PIM is determined at a subtractor 414. In some examples, the optimal model parameters of the neural network model are estimated by minimizing the mean squared error between the predicted PIM and the true PIM for the supervised learning dataset. Particularly, in some embodiments, the non-linear machine learning model 400 comprises a set of model parameters, and wherein the set of model parameters are estimated as part of training the non-linear machine learning model 400 by minimizing the mean squared error between the predicted PIM signal and labelled data taken from a supervised learning dataset. The parameters to be estimated comprise the weight and bias terms for the nonlinear as well as the linear network layers. The estimation may be performed using any suitable approach, such as (but not limited to) stochastic gradient descent. In some examples, the neural network model implements one or more layers that are fully connected (dense), convolutional, or any other known layer implementation. Each layer comprises several neurons that apply multiplicative weights and additive bias terms, followed by a nonlinear transform such as a Rectified linear unit (ReLU), the hyperbolic tangent function (tanh), etc. In some examples, the output of the last neural network layer is transformed via a weighted linear combination to generate the predicted PIM signal. Particularly, in some embodiments, the predicted PIM signal is defined by the output from the non-linear machine learning model 400 as transformed via a weighted linear combination. This predicted PIM signal may be implemented as a complex-valued scalar or any equivalent representation. In some examples, the non-linear machine learning model 400 is used to cancel PIM from incoming receive signals by subtracting the PIM prediction from the receive signal. In some examples, the non-linear machine learning model 400 is used to predict multiple PIM signals generated from a common PIM source, or multiple common PIM sources. These predicted PIM signals generally correspond to multiple receive frequency bands or antenna ports of interest. A band limited low pass FIR filter with passband corresponding to the receive frequency band, or bands, of interest might be used to dampen out-of-band components of the predicted PIM signal prior to PIM cancellation. Further, the mean of the predicted PIM signal might also be subtracted to ensure that the final PIM-cancelled receive signal has zero mean.

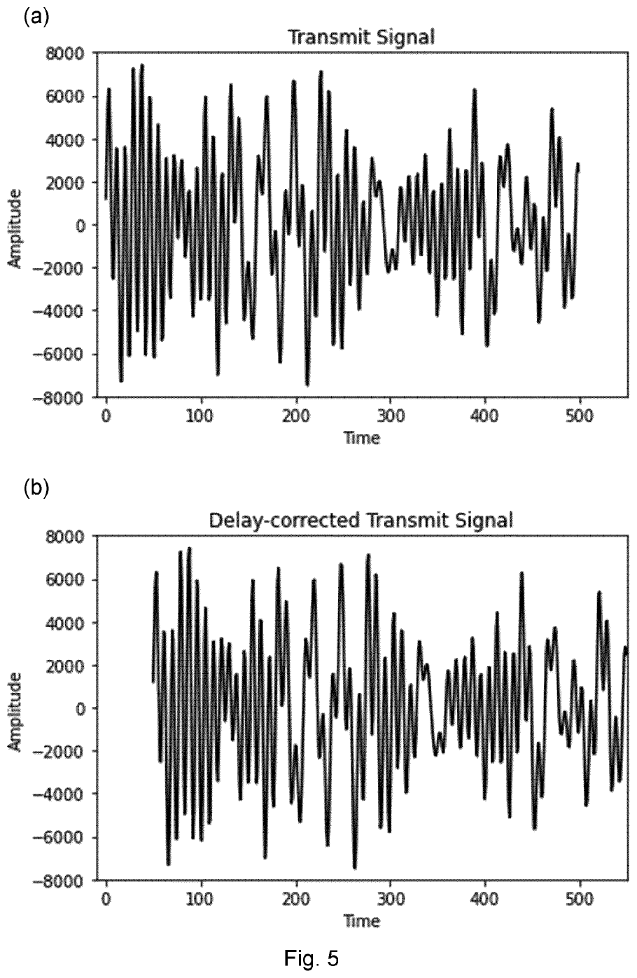

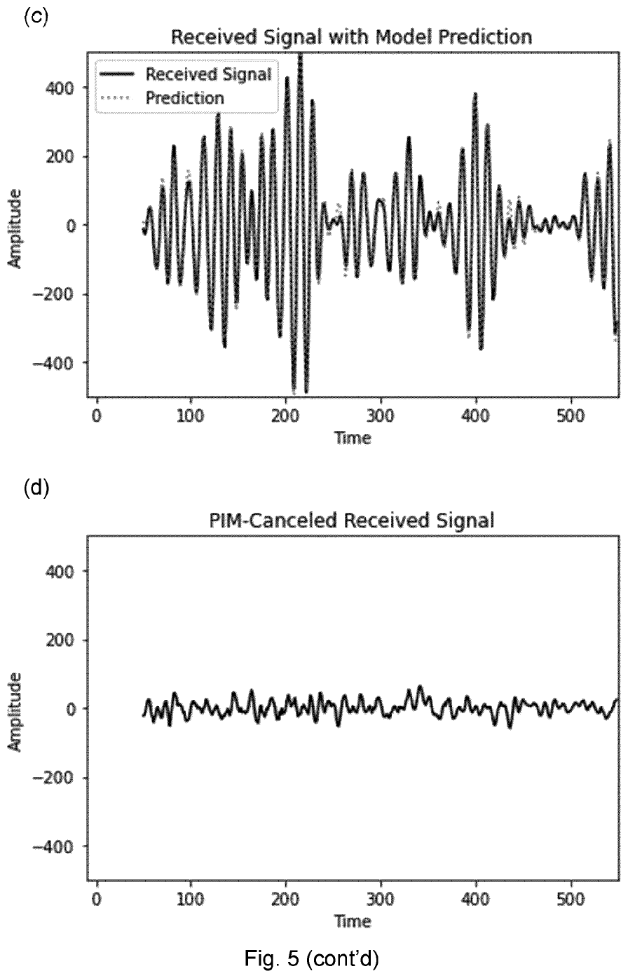

Reference is next made to FIG. 5 which in turn shows processed signals at different stages of the PIM cancellation. It is noted that only the real-valued component of the complex-valued signals is shown at the different stages. In FIG. 5(a) is shown an example of a transmit signal, i.e., a signal as transmitted over-the-air from the antenna system 116. In FIG. 5(b) is shown an example of a delay-corrected transmit signal, representing the transmit signal as delay-corrected to account for the time the given transmit signal takes to interact with the PIM source and be received by the receive radio chain 114. Such delay-corrected transmit signals are passed to the disclosed non-linear machine learning model 400 for training and feature reduction. In FIG. 5(c) is shown an incoming receive signal before PIM cancellation. Finally, in FIG. 5(d) is shown the resulting, cleaned, receive signal after PIM removal.

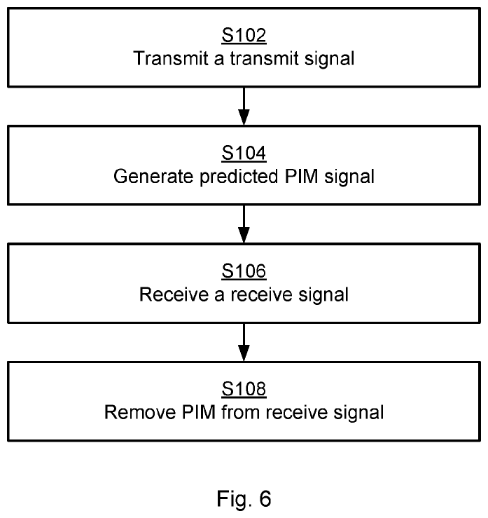

FIG. 6 is a flowchart illustrating embodiments of methods for PIM removal in a network node 110. There could be different causes of the PIM. In some examples, the PIM is caused by a PIM source 190 external to the network node 110. Such a PIM source is referred to as an external PIM source. In some examples, the PIM is caused by an electric component, such as a passive electric component, of the transmit radio chain 112. Such a PIM source is referred to as an internal PIM source. In some examples, there is both an external PIM source and an internal PIM source. In some examples, there is more than one external PIM source and/or more than one internal PIM source.

The network node 110 comprises a transmit radio chain 112, a receive radio chain 114, and an antenna system 116. The methods are performed by the controller 1500, 1600. The methods are advantageously provided as computer programs 1720.

S102: The controller 1500, 1600 transmits a transmit signal 180 via the transmit radio chain 112 and over-the-air from the antenna system 116.

S104: The controller 1500, 1600 generates a predicted PIM signal for the transmit signal 180 using a non-linear machine learning model 400 by transforming the transmit signal 180 to a signal feature representation composed of delay-aligned discrete-time samples and at least one discrete-time phase offset. The non-linear machine learning model 400 is of an architecture that uses a first neural network column for the delay-aligned discrete-time samples and a second neural network column for the at least one discrete-time phase offset. The predicted PIM signal is obtained as output from the non-linear machine learning model 400 when the signal feature representation is fed as input to the non-linear machine learning model 400.

S106: The controller 1500, 1600 receives a receive signal 185 over-the-air at the antenna system 116 and via the receive radio chain 114.

S108: The controller 1500, 1600 removes PIM from the receive signal 185 by subtracting the predicted PIM signal from the receive signal 185.

Embodiments relating to further details of PIM removal in a network node 110 as performed by the controller 1500, 1600 will now be disclosed.

In general terms, the discrete-time phase offset depends on a relation between the center frequencies of the transmit signals and the center frequencies of the receive signal. Particularly, in some embodiments, the transmit signal 180 is transmitted with a first center frequency and the receive signal 185 is received with a second center frequency, and the at least one discrete-time phase offset is a function of a difference between the first center frequency and the second center frequency.

Aspects of transforming source signals into a feature representation suitable for PIM cancellation will be disclosed next.

In general terms, the signals used as input to the non-linear machine learning model comprise one or more complex-valued transmit signals (e.g., representing user plane data). Further, information of the frequency offset, time delay estimates, and any additional features (including, but not limited to, absolute values of the transmit signals, partial non-linear terms created by transmit signals etc.) might also be obtained for generation of the signal feature representation.

In one example, the transmit signals are discrete-time samples of the continuous transmit waveform. The complex signals could be represented in different formats (e.g., in terms of real and imaginary parts or in terms of magnitude and phase representation). The transmit signals are delay-aligned with the receive signal before being used in the signal feature representation. For the signal feature representation, each sample of the transmit signal is concatenated into a one-dimensional tensor. Particularly, in some embodiments, in the signal feature representation, each of the delay-aligned discrete-time samples comprises a first real component and a first imaginary component, where the first real component and the first imaginary component for each of the delay-aligned discrete-time samples are concatenated into a respective first one-dimensional tensor. Further, in the signal feature representation, each of the at least one discrete-time phase offset comprises a second real component and a second imaginary component, where the second real component and the second imaginary component for each of the at least one discrete-time phase offset are concatenated into a respective second one-dimensional tensor.

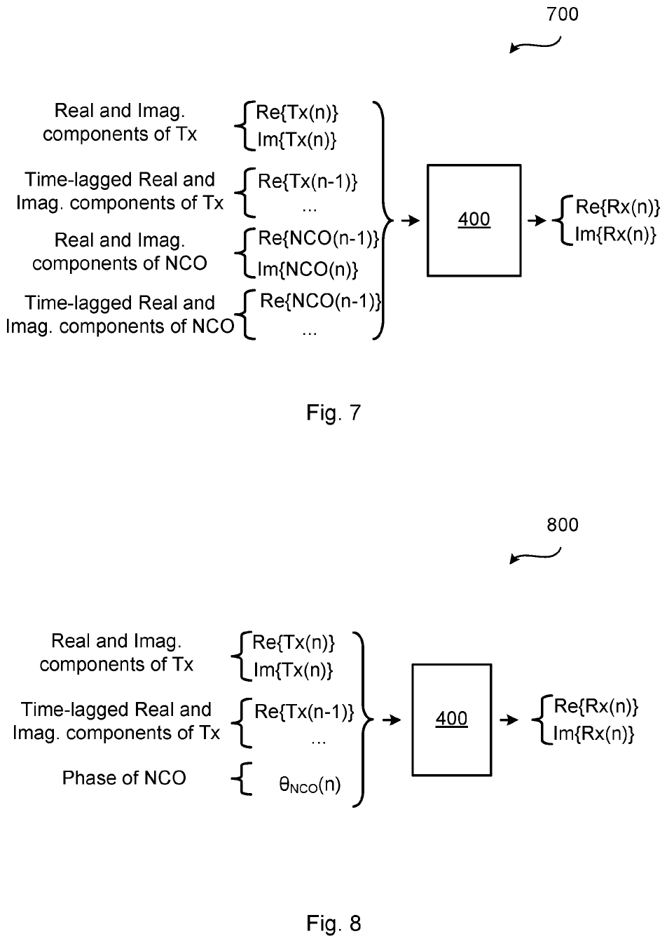

In one example, the frequency shift is represented as the discrete-time phase offsets at the sampling instances. The real and imaginary component of each phase offset term is concatenated into a one-dimensional tensor, as in the above defined NCO features. A simplified visualization of the feature representation in this example, when the predicted PIM at sampling instance n is represented with its real and imaginary component, and when the transmit signals are represented with the real and imaginary components of the discrete-time samples, is shown in FIG. 7. In further detail, FIG. 7 at 700 schematically illustrates an architecture of a non-linear machine learning model where the frequency shift is modelled with NCO features. In FIG. 7 “Tx” is short for transmit signal. This architecture can be regarded as modelling a non-linear finite impulse response (FIR) filter in the time domain.

In some examples, the NCO features representing the frequency shift are compressed. Particularly, in some embodiments, the signal feature representation comprises discrete-time phase offsets as compressed. In further detail, it has been found that, with a negligible performance loss, the frequency shift can be represented with just one phase offset from a single sampling instance from the corresponding transmit signal. Furthermore, it might not be necessary to separate such phase offset into its real and imaginary component. Thus, instead of expressing the frequency shifts with real and imaginary components of time series with length D (where D denotes the maximum sampling lag) the frequency shifts can be expressed directly as a scalar value. Such a scalar value for sampling instance n is denoted θ_{NCO}(n) and can be retrieved from the NCO feature as:

$${θ}_{NCO} ( n ) = arctan ( \frac{Im \{ NCO ( n ) \}}{Re \{ NCO ( n ) \}} ) ,$$

where Im{NCO(n)} is the imaginary part of the NCO feature at sampling instance n and Re{NCO(n)} is the real part of the NCO feature at sampling instance n. FIG. 8 at 800 schematically illustrates an architecture of a non-linear machine learning model where the frequency shift is expressed with just one phase offset from a single sampling instance. In FIG. 8 “Tx” is short for transmit signal. Hence, the architecture in FIG. 8 is equal to that of FIG. 7 except that here the frequency shift is expressed with just one phase offset. Particularly, in some embodiments, the signal feature representation comprises discrete-time phase offsets for just one single sampling instant.

Aspects of how the feature representation might be manipulated towards lowering input dimensionality and memory footprint will be disclosed next.

In general terms, the feature representation as disclosed above can be manipulated to reduce the input dimensionality. This enables the computational, as well as the implementational, complexity of the PIM cancellation to be reduced. It further enables the memory footprint to be reduced, whilst increasing the learning efficiency of the non-linear machine learning model.

In some examples, the number of lagged sampling instances used is reduced by ranking them. Particularly, in some embodiments, the signal feature representation comprises less than all delay-aligned discrete-time samples, and wherein which of all delay-aligned discrete-time samples that are included in the signal feature representation is determined using a feature attribution procedure. This ranking could be implemented using a feature attribution method which assigns a score to each input feature based on their contribution to the PIM prediction made by the non-linear machine learning model. If the feature attribution score for an input feature is high, and therefore the contribution to the output is significant, the feature is assumed to be of high importance. Backpropagation-based feature attribution methods such as Layer-wise Relevance Propagation (LRP) are fast, reliable, and do not require large computational resources. Not all lagged sampling instances of the PIM source features are needed to predict the PIM, and the feature attribution methods can be utilized to filter out unimportant lagged time instance samples.

One example procedure for this example will be disclosed next for completeness of this disclosure.

Assume that a baseline non-linear machine learning model with full set of lagged PIM source features n−0, . . . , n−D+1, where D denotes the maximum sampling lag, is trained.

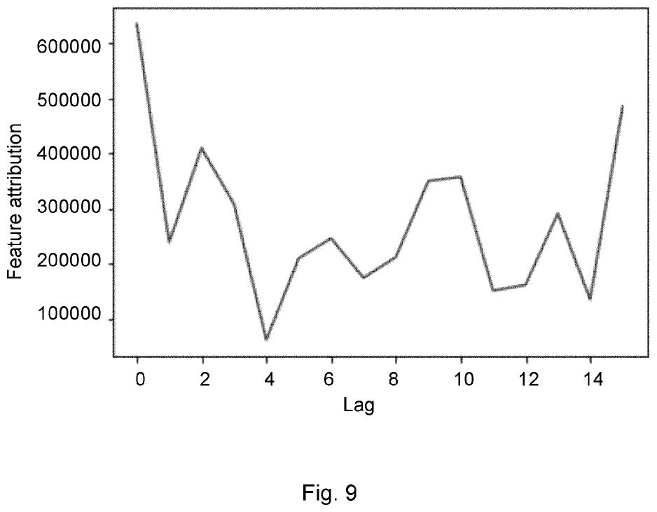

A feature attribution method is then applied to assign scores to each lagged sample based on their contribution when predicting over a set of data samples. This score is then used to filter out the least important lags, either by a threshold value or by selecting a specified number of lags with the highest score. Depending on the trade-off between performance and model complexity, more or less time lags could be used. In FIG. 9 is shown an example of the accumulated score retrieved for each lag in the transmit signals, taken from 1000 data samples in a test set for a certain testcase. Here the maximum sampling lag was set to 16. From FIG. 9 can be seen that the sampling instance predicted for, with lag 0, is the most important when predicting the introduced PIM in these 1000 data samples. For example, if the 3 most important lags are to be kept in the example in FIG. 9, lag 0, lag 2, and lag 15 would be returned.

An updated non-linear machine learning model which as input takes the reduced set of lagged PIM source features is then trained. In the present example with reference to FIG. 9, an updated non-linear machine learning model that uses lag 0, lag 2, and lag 15 would be trained.

Aspects of designing and provisioning a non-linear machine learning model with trainable parameters that takes as input manipulated features and estimates a PIM signal will be disclosed next.

As disclosed above, the non-linear machine learning model 400 is of an architecture 1000 that uses a first neural network column 1010 for the delay-aligned discrete-time samples and a second neural network column 1020 for the at least one discrete-time phase offset. One motivation for such an architecture variant stems from the traditional PIM cancellation approach of first using the transmit signals to calculate polynomial basis functions from which the PIM will be fit and then applying the appropriate frequency shift to these basis functions using the NCO features. One advantage of simulating this process using artificial neural networks is that there are no assumptions on the functional relationship (e.g., polynomial) between the transmit and receive signals.

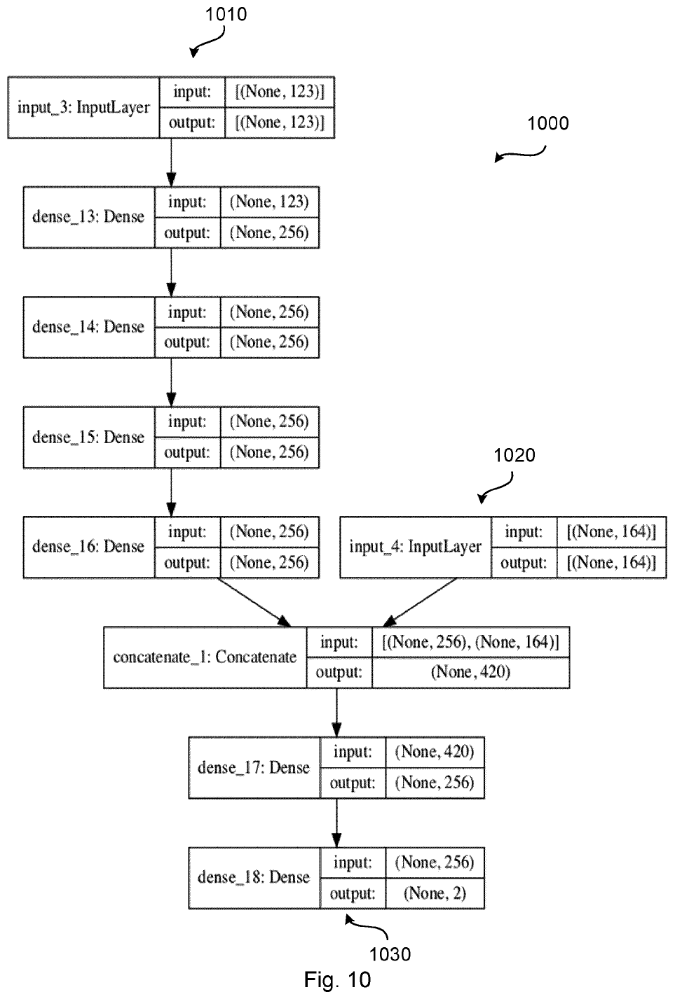

One example two-column architecture 1000 is shown in FIG. 10. According to the illustrated two-column architecture 1000, separate neural network columns 1010 and 1020 are used for the transmit signals and the NCO features, respectively. Column 1010 for the transmit signals consist of five layers and column 1020 for the NCO features consists of one single layer. The notations “input_3”, “dense_13”, etc. are the names for the different layers. The term “InputLayer” refers to the input layer for each column 1010, 1020. The term “Dense” refers to a fully-connected neural network layer. Each fully-connected neural network layer could be replaced with another type of layer (e.g., a convolutional neural network, CNN, layer, or a complex-valued neural network, CVNN, layer, or a complex valued convolution neural network, CVCNN, layer). The term “Concatenate” refers to a layer implementing concatenation of columns 1010 and 1020. The term “x” in the notation “[(None, x)]” refers to that the layer has x number of inputs or outputs and the term “None” represents the number of samples that are moving through the model at a given time. For instance, the model predictions can be run for a single sample or for 100 samples. The term “None” indicates that that variable is some integer dependent on how many samples that are fed to the model at any instance. The dimensionality of the inputs to each column 1010, 1020 can vary depending on the type of PIM and number of contributing antennas. After the final fully-connected, or CNN/CVNN/CVCNN, layer, the NCO features are concatenated with the output of the neural network column for the transmit signals in a single column 1030. This single column consists of three layers, if including the concatenation layer. Particularly, in some embodiments, the first neural network column 1010 comprises a first fully-connected layer and the second neural network column 1020 comprises a second fully-connected layer. The non-linear machine learning model 400 further comprises a common fully-connected layer, and the second neural network column 1020 is merged with the first neural network column 1010 at the common fully-connected layer. In the illustrative example of FIG. 10, this fully-connected layer is, in the single column 1030, passed to an additional fully-connected layer before PIM predictions are made in the final output layer.

Although the architecture presented in FIG. 10 has only two columns, the architecture can be extended to have multiple columns with more than two types of input features. In that case, additional neural network columns could be added before the concatenation step. Each of these neural network columns can also have different types of layers depending on the data structure of its input feature. For example, one column could process the transmit signals as a time series using one-dimensional CNN layers, whilst another column could process additional tabular input features using fully-connected layers.

Aspects of training the non-linear machine learning model to learn common nonlinear basis functions for several PIM source and PIM signal configurations will be disclosed next.

In general terms, training a separate non-linear machine learning model for each PIM source has a relatively higher complexity. Complexity can be reduced by adopting fixed, non-linear, basis functions across multiple PIM sources. In some embodiments, the set of model parameters define a set of non-linear basis functions in the non-linear machine learning model 400. Next will be disclosed how the non-linear machine learning model complexity can be reduced by training common nonlinear basis functions across multiple PIM sources.

Subsequently, a single non-linear machine learning model 400 can be used to accurately model the PIM for multiple PIM sources. One advantage is that these nonlinear basis functions are not fixed but instead are learnt from training data, which provides a better fit.

In one example, the nonlinear basis functions are modeled using artificial neural networks (ANNs). Such an ANN comprises a succession of nonlinear transforms, which are composed of trainable weight and bias terms followed by a nonlinear activation function. The set of nonlinear basis functions is defined as the mapping from the first (or input) ANN layer to the output of the last nonlinear layer.

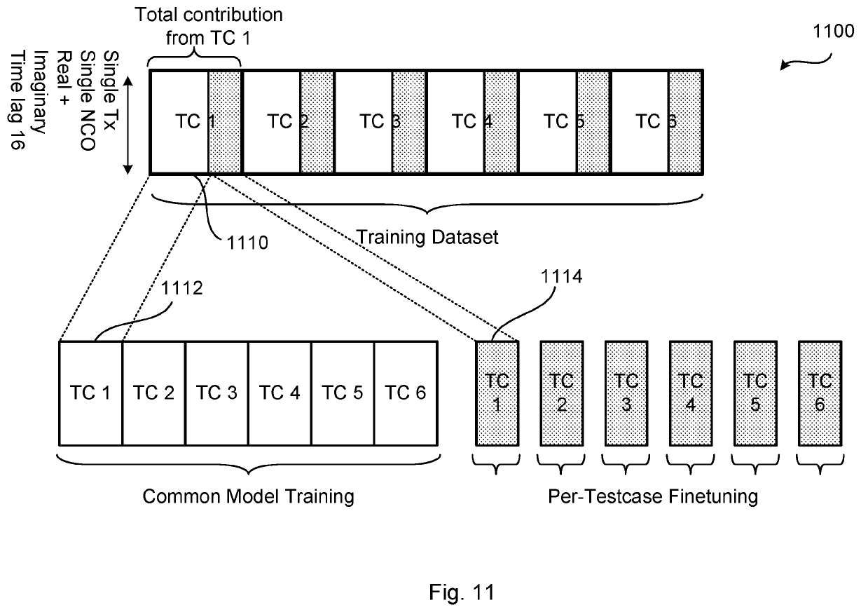

In one example, the training dataset for the nonlinear basis function learning is obtained by aggregating data from several testcases, where each testcase corresponds to a unique PIM source configuration. Particularly, in some embodiments, each of the different PIM sources 190 represents a respective testcase, where each testcase corresponds to a respective PIM source configuration. Such a dataset preparation is illustrated in FIG. 11. In particular, in FIG. 11 is at 1100 illustrated an example of nonlinear basis function learning using training data aggregated from several testcases (TC; denoted TC 1, TC 2, . . . , TC 6), where each testcase corresponds to a unique PIM source configuration. The dataset aggregation can involve concatenation, interleaving, sorting, or randomization of data samples from the component testcases. In some example, the nonlinear basis functions are obtained by extracting the transfer function of the nonlinear layers of the trained ANN. One mechanism for this example involves saving the ANN architecture and the learnt parameter values to disk. In one example (as in FIG. 11), the aggregated training dataset contains equal number of data samples from each component testcase. In another example, the aggregated training dataset contains varying number of data samples from the component testcases, for example based on the relative importance of individual PIM sources, order of the PIM signal, signal power levels, or some related metric. In one example, the aggregated dataset is used to train the ANN. The training mechanism follows the steps described above. In essence, the training minimizes the average loss between the ANN output and the target PIM signal, where this average is computed over the aggregate training dataset. Particularly, in some embodiments, the set of model parameters are estimated for different PIM sources 190. Since the ANN is trained with data from multiple PIM sources, the optimally learnt ANN weights will correspond to a non-linear machine learning model that is common across the PIM sources as well.

Aspects of training the non-linear machine learning model to learn linear weights for a specific PIM source and PIM signal configuration will be disclosed next.

In some embodiments, the non-linear machine learning model 400 is trained with a first supervised learning dataset that is common for all the different PIM sources 190 and a separate respective supervised learning dataset per each of the different PIM sources 190. In FIG. 11, the first supervised learning dataset that is common for all the different PIM sources for TC 1 is identified at reference numeral 1112 and the supervised learning dataset for one specific PIM source is identified at reference numeral 1114. Together the datasets 1112 and 1114 form the total contribution to the training data set from TC 1, as illustrated at reference numeral 1110.

In some examples, a new ANN is created by concatenating the nonlinear basis functions with a linear output layer. In this case, the nonlinear transform layers correspond to the learnt nonlinear basis functions and are “frozen”, that is, the parameters for these nonlinear layers cannot be changed or updated. However, the parameters of the final, linear, layer may be updated. In some examples, data samples for a certain PIM source is collected within a training dataset. This per-testcase dataset preparation is illustrated in FIG. 11. The ANN might thereby be finetuned by being trained with the per-testcase dataset for the given PIM source to minimize the average loss between the ANN output and the per-testcase dataset. This training follows the steps described above. Since only the linear layer parameters can be updated, this training amounts to learning linear combining weights for the nonlinear basis functions and for the given PIM source. In another example, the ANN is finetuned by the non-linear machine learning model being trained in an online fashion, where data samples obtained from a staged or live deployment are used to learn linear combining weights for the nonlinear basis functions. Particularly, in some embodiments, the non-linear machine learning model 400 is trained with the separate respective supervised learning dataset per each of the different PIM sources 190 either using a dedicated per-testcase dataset of transmit signals 180 or using transmit signals 180 transmitted towards user equipment during live operation of the network node 110. Such online training can be implemented using (linear) adaptive filtering mechanisms, for example the LMS algorithm.

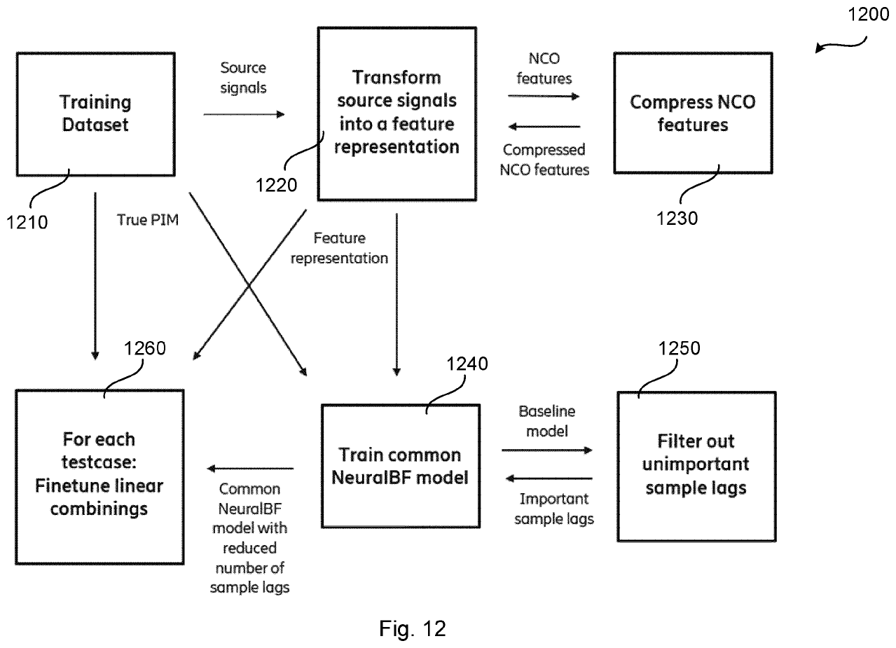

Reference is next made to FIG. 12 which shows a block diagram 1200 for training the non-linear machine learning model for PIM cancellation. Source signals are in block 1210 extracted from a supervised dataset. The source signals are in block 1220 transformed into a feature representation, in which the NCO features are further compressed in block 1230. The feature representation and PIM signals extracted from the supervised dataset are used to train a two-column common nonlinear basis functions based non-linear machine learning model in block 1240. The common nonlinear basis functions based non-linear machine learning model acts as a baseline model from which unimportant sample lags are filtered out in block 1250. A new two-column common nonlinear basis functions based non-linear machine learning model with a reduced number of sample lags is then trained, also in block 1240. The linear combinations in the common nonlinear basis functions model are fine-tuned to each separate PIM source configuration of interest so as to define the final, trained, non-linear machine learning model in block 1260.

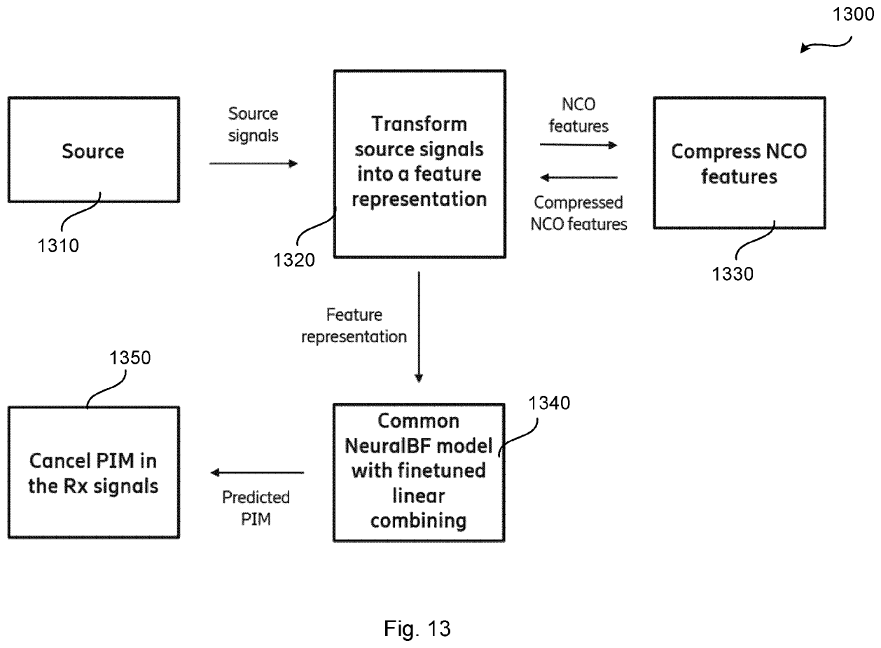

Reference is next made to FIG. 13 which shows a block diagram 1300 for performing PIM cancellation using the non-linear machine learning model. Source signals are extracted from the transmit signals and the NCO features in block 1310. The source signals are transformed into a feature representation in block 1320 and the NCO features are further compressed in block 1330. The feature representation is used as input to the non-linear machine learning model with a linear combining fine-tuned for the specific PIM source configuration under consideration in block 1340. The non-linear machine learning model predicts the PIM signal introduced in the receive signal. The predicted PIM signal is in block 1340 used to cancel out PIM from the receive signals.

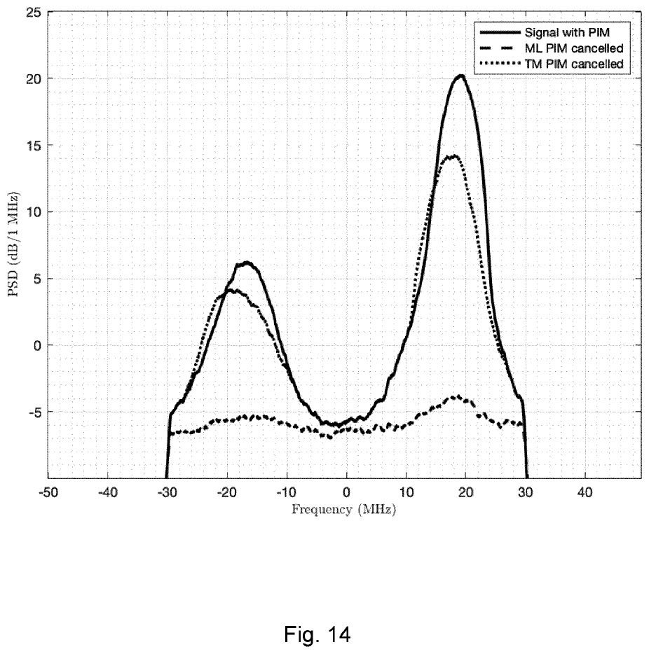

Simulation results will be disclosed next with reference to FIG. 14. FIG. 14 visualizes, through a power spectral density (PSD) plot, a comparison between a reference PIM cancellation method (denoted TM as in traditional method) and the herein disclosed PIM cancellation method (denoted ML as in machine learning) applied to a PIM signal. The PSD of the PIM signal is shown with a solid line. The PSD of the signal resulting from PIM cancellation using a reference PIM cancellation method is shown with a dotted line. The PSD of the signal resulting from PIM cancellation using the herein disclosed PIM cancellation method is shown with a dashed line. The PIM signal represents the receive signal including PIM. From FIG. 14 follows that the herein disclosed techniques for PIM cancelation are robust and stable compared to existing PIM cancelation approaches. Indeed, the improvement in receiver sensitivity degradation is significantly higher with the herein disclosed PIM cancellation method than the reference method. In other words, the amount of PIM cancelled by the herein disclosed PIM cancellation method is much higher than the amount of PIM cancelled by the reference method.

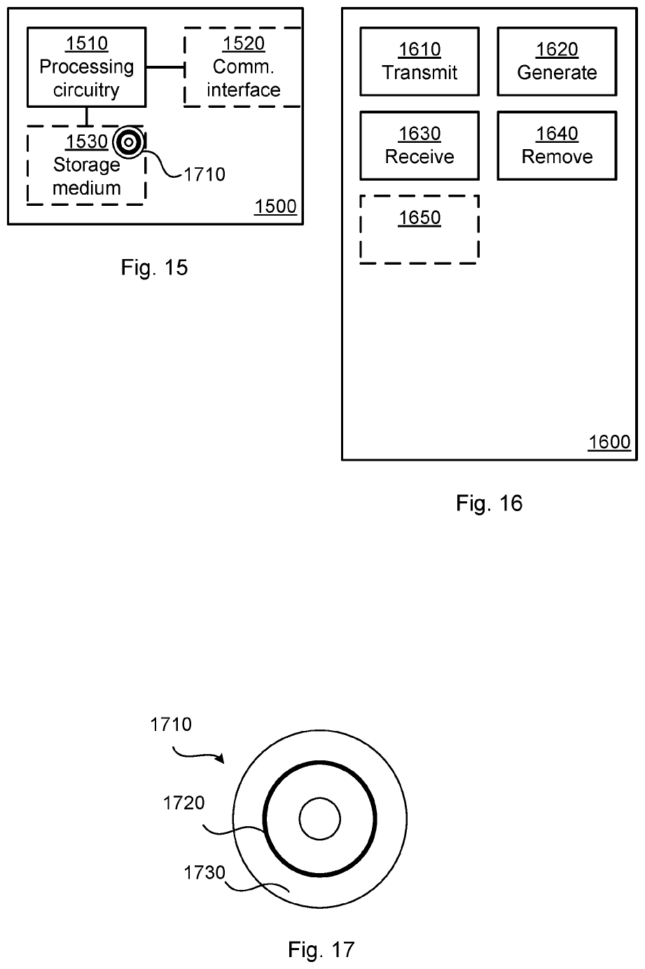

FIG. 15 schematically illustrates, in terms of a number of functional units, the components of a controller 1500 according to an embodiment. Processing circuitry 1510 is provided using any combination of one or more of a suitable central processing unit (CPU), multiprocessor, microcontroller, digital signal processor (DSP), etc., capable of executing software instructions stored in a computer program product 1710 (as in FIG. 17), e.g. in the form of a storage medium 1530. The processing circuitry 1510 may further be provided as at least one application specific integrated circuit (ASIC), or field programmable gate array (FPGA).

Particularly, the processing circuitry 1510 is configured to cause the controller 1500 to perform a set of operations, or steps, as disclosed above. For example, the storage medium 1530 may store the set of operations, and the processing circuitry 1510 may be configured to retrieve the set of operations from the storage medium 1530 to cause the controller 1500 to perform the set of operations. The set of operations may be provided as a set of executable instructions.

Thus the processing circuitry 1510 is thereby arranged to execute methods as herein disclosed. The storage medium 1530 may also comprise persistent storage, which, for example, can be any single one or combination of magnetic memory, optical memory, solid state memory or even remotely mounted memory. The controller 1500 may further comprise a communications interface 1520 at least configured for communications with the antenna system 116. As such the communications interface 1520 may comprise one or more transmitters and receivers, comprising analogue and digital components. The processing circuitry 1510 controls the general operation of the controller 1500 e.g. by sending data and control signals to the communications interface 1520 and the storage medium 1530, by receiving data and reports from the communications interface 1520, and by retrieving data and instructions from the storage medium 1530. Other components, as well as the related functionality, of the controller 1500 are omitted in order not to obscure the concepts presented herein.

FIG. 16 schematically illustrates, in terms of a number of functional modules, the components of a controller 1600 according to an embodiment. The controller 1600 of FIG. 16 comprises a number of functional modules; a transmit module 1610 configured to perform step S102, a generate module 1620 configured to perform step S104, a receive module 1630 configured to perform step S106, and a remove module 1640 configured to perform step S108. The controller 1600 of FIG. 16 may further comprise a number of optional functional modules, as represented by functional module 1650. In general terms, each functional module 1610:1650 may in one embodiment be implemented only in hardware and in another embodiment with the help of software, i.e., the latter embodiment having computer program instructions stored on the storage medium 1530 which when run on the processing circuitry makes the controller 1600 perform the corresponding steps mentioned above in conjunction with FIG. 16. It should also be mentioned that even though the modules correspond to parts of a computer program, they do not need to be separate modules therein, but the way in which they are implemented in software is dependent on the programming language used. Preferably, one or more or all functional modules 1610:1650 may be implemented by the processing circuitry 1510, possibly in cooperation with the communications interface 1520 and/or the storage medium 1530. The processing circuitry 1510 may thus be configured to from the storage medium 1530 fetch instructions as provided by a functional module 1610:1650 and to execute these instructions, thereby performing any steps as disclosed herein.

The controller 1500, 1600 may be provided as a standalone device or as a part of at least one further device. For example, the controller 200 may be provided in a node of the radio access network and might be part of, integrated with, or collocated with, the network node 110, for example with the antenna system 116. Alternatively, functionality of the controller 1500, 1600 may be distributed between at least two devices, or nodes. Thus, a first portion of the instructions performed by the controller 1500, 1600 may be executed in a first device, and a second portion of the of the instructions performed by the controller 1500, 1600 may be executed in a second device; the herein disclosed embodiments are not limited to any particular number of devices on which the instructions performed by the controller 1500, 1600 may be executed. Hence, the methods according to the herein disclosed embodiments are suitable to be performed by a controller 1500, 1600 residing in a cloud computational environment. Therefore, although a single processing circuitry 1510 is illustrated in FIG. 15 the processing circuitry 1510 may be distributed among a plurality of devices, or nodes. The same applies to the functional modules 1610:1650 of FIG. 16 and the computer program 1720 of FIG. 17.

FIG. 17 shows one example of a computer program product 1710 comprising computer readable storage medium 1730. On this computer readable storage medium 1730, a computer program 1720 can be stored, which computer program 1720 can cause the processing circuitry 1510 and thereto operatively coupled entities and devices, such as the communications interface 1520 and the storage medium 1530, to execute methods according to embodiments described herein. The computer program 1720 and/or computer program product 1710 may thus provide means for performing any steps as herein disclosed.

In the example of FIG. 17, the computer program product 1710 is illustrated as an optical disc, such as a CD (compact disc) or a DVD (digital versatile disc) or a Blu-Ray disc. The computer program product 1710 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1720 is here schematically shown as a track on the depicted optical disk, the computer program 1720 can be stored in any way which is suitable for the computer program product 1710.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for passive intermodulation, PIM, removal in a network node, the network node comprising a transmit radio chain, a receive radio chain, and an antenna system, the method being performed by a controller, the method comprising:
transmitting a transmit signal via the transmit radio chain and over-the-air from the antenna system;
generating a predicted PIM signal for the transmit signal using a non-linear machine learning model by transforming the transmit signal to a signal feature representation composed of delay-aligned discrete-time samples and at least one discrete-time phase offset, wherein the non-linear machine learning model is of an architecture that uses a first neural network column for the delay-aligned discrete-time samples and a second neural network column for the at least one discrete-time phase offset, and wherein the predicted PIM signal is obtained as output from the non-linear machine learning model when the signal feature representation is fed as input to the non-linear machine learning model;
receiving a receive signal over-the-air at the antenna system and via the receive radio chain; and
removing PIM from the receive signal by subtracting the predicted PIM signal from the receive signal.

2. The method according to claim 1, wherein the transmit signal is transmitted with a first center frequency and the receive signal is received with a second center frequency, and wherein the at least one discrete-time phase offset is a function of a difference between the first center frequency and the second center frequency.

3. The method according to claim 1, wherein the signal feature representation further is composed of any, or any combination, of: absolute value of the transmit signals, partial non-linear terms created from the transmit signal, statistics of N previous delay-aligned discrete-time samples, a weighted linear combination of the N previous delay-aligned discrete-time samples.

4. The method according to claim 1, wherein the predicted PIM signal is defined by the output from the non-linear machine learning model as transformed via a weighted linear combination.

5. The method according to claim 1, wherein, in the signal feature representation, each of the delay-aligned discrete-time samples comprises a first real component and a first imaginary component, wherein the first real component and the first imaginary component for each of the delay-aligned discrete-time samples are concatenated into a respective first one-dimensional tensor, and each of the at least one discrete-time phase offset comprises a second real component and a second imaginary component, wherein the second real component and the second imaginary component for each of the at least one discrete-time phase offset are concatenated into a respective second one-dimensional tensor.

6. The method according to claim 1, wherein the signal feature representation comprises discrete-time phase offsets as compressed.

7. The method according to claim 1, wherein the signal feature representation comprises discrete-time phase offsets for just one single sampling instant.

8. The method according to claim 1, wherein the signal feature representation comprises less than all delay-aligned discrete-time samples, and wherein which of all delay-aligned discrete-time samples that are included in the signal feature representation is determined using a feature attribution procedure.

9. The method according to claim 1, wherein the first neural network column comprises a first fully-connected layer and the second neural network column comprises a second fully-connected layer, wherein the non-linear machine learning model further comprises a common fully-connected layer, and wherein the second neural network column is merged with the first neural network column at the common fully-connected layer.

10. The method according to claim 1, wherein the non-linear machine learning model comprises a set of model parameters, and wherein the set of model parameters are estimated as part of training the non-linear machine learning model by minimizing mean squared error between the predicted PIM signal and labelled data taken from a supervised learning dataset.

11. The method according to claim 1, wherein the set of model parameters are estimated for different PIM sources.

12. The method according to claim 11, wherein each of the different PIM sources represents a respective testcase, and wherein each testcase corresponds to a respective PIM source configuration.

13. The method according to claim 1, wherein the non-linear machine learning model is trained with a first supervised learning dataset that is common for all the different PIM sources and a separate respective supervised learning dataset per each of the different PIM sources.

14. The method according to claim 13, wherein the non-linear machine learning model is trained with the separate respective supervised learning dataset per each of the different PIM sources either using a dedicated per-testcase dataset of transmit signals or using transmit signals transmitted towards user equipment during live operation of the network node.

15. The method according to claim 1, wherein the set of model parameters define a set of non-linear basis functions in the non-linear machine learning model.

16. The method according to claim 1, wherein the PIM is caused by a PIM source external to the network node.

17. The method according to claim 1, wherein the PIM is caused by an electric component of the transmit radio chain.

18. A controller for passive intermodulation, PIM, removal in a network node, the network node comprising a transmit radio chain, a receive radio chain, and an antenna system, the controller comprising processing circuitry, the processing circuitry being configured to cause the controller to:
transmit a transmit signal via the transmit radio chain and over-the-air from the antenna system;
generate a predicted PIM signal for the transmit signal using a non-linear machine learning model by transforming the transmit signal to a signal feature representation composed of delay-aligned discrete-time samples and at least one discrete-time phase offset, wherein the non-linear machine learning model is of an architecture that uses a first neural network column for the delay-aligned discrete-time samples and a second neural network column for the at least one discrete-time phase offset, and wherein the predicted PIM signal is obtained as output from the non-linear machine learning model when the signal feature representation is fed as input to the non-linear machine learning model;
receive a receive signal over-the-air at the antenna system and via the receive radio chain; and
remove PIM from the receive signal by subtracting the predicted PIM signal from the receive signal.

19. (canceled)

20. (canceled)

21. A computer program for passive intermodulation, PIM, removal in a network node, the network node comprising a transmit radio chain, a receive radio chain, and an antenna system, the computer program comprising computer code which, when run on processing circuitry of a controller, causes the controller to:
transmit a transmit signal via the transmit radio chain and over-the-air from the antenna system;
generate a predicted PIM signal for the transmit signal using a non-linear machine learning model by transforming the transmit signal to a signal feature representation composed of delay-aligned discrete-time samples and at least one discrete-time phase offset, wherein the non-linear machine learning model is of an architecture that uses a first neural network column for the delay-aligned discrete-time samples and a second neural network column for the at least one discrete-time phase offset, and wherein the predicted PIM signal is obtained as output from the non-linear machine learning model when the signal feature representation is fed as input to the non-linear machine learning model;
receive a receive signal over-the-air at the antenna system and via the receive radio chain; and
remove PIM from the receive signal by subtracting the predicted PIM signal from the receive signal.

22. (canceled)
